(19) United States
(12) Patent Application Publication
(10) Pub. No.: US 2007/0091346 A1
(43) Pub. Date: Apr. 26, 2007

(54) Network print system

(75) Inventors: Kazuhiro Ogura, Fujisawa-shi (JP); Shinji Makishima, Tokyo (JP); Akihiro Mizutani, Tokyo (JP); Toshihiro Ida, Tokyo (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/256,948

(22) Filed: Oct. 25, 2005

(51) Int. Cl. G06K 15/00

(52) U.S. Cl. 358/1.14; 358/1.16

(57) ABSTRACT

Upon executing private print processing, an image forming apparatus acquires a list of spoolers from an IC card which registers information of spoolers which save a print job of a private print mode, and simultaneously requests the acquired spoolers to send a list of print jobs of the user of interest. The image forming apparatus presents, to the user, the list of print jobs acquired from the spoolers in response to the request. When a user selects a desired print job from the presented print jobs, the image forming apparatus downloads the selected print job and executes print processing.

### BACKGROUND OF THE INVENTION

1. Field of the Invention

The present invention relates to an image forming apparatus and a network print system, which perform image formation processing in response to a print request from, e.g., a terminal connected via a network.

2. Description of the Related Art

Conventionally, in a network print system, a printer executes print processing in response to a print request from each device connected to a network. In this case, a print request from each device on the network to the printer is spooled as a print job by a spooler connected to the network. In this case, the print job spooled by the spooler is downloaded to the printer in accordance with, e.g., an operation at the printer, and is printed.

For example, Jpn. Pat. Appln. KOKAI Publication No. 2002-132464 has proposed a technique that pertains to a network print system, network print control method, spool apparatus, and the like. In the system described in Jpn. Pat. Appln. KOKAI Publication No. 2002-132464, a print request to a printer is spooled as a print job by a spool server (spooler) which is equipped on the network.

The spool server spools the print job while giving a job number to it, and returns the job number to a device as the print request source. The print job spooled by the spool server is downloaded from the spool server in accordance with input of the job number at the printer, and undergoes print processing.

If there are a plurality of spool servers, the printer inquires of a given spooler about the presence/absence of a print job of the designated job number. If this spool server does not spool any print job of the designated job number, that spool server inquires of another spool server about the presence/absence of the print job of the designated job number. Therefore, in such system, if one spool server that receives the inquiry from the printer does not spool a desired print job, that spool server sends an inquiry to another spool server. For this reason, if there are a plurality of spool servers, it takes much time to retrieve the desired print job.

### BRIEF SUMMARY OF THE INVENTION

An image forming apparatus according to one aspect of the present invention comprises a user authentication unit which authenticates a user, an acquisition unit which acquires information indicating spoolers used by the user whose authentication by the user authentication unit has succeeded, a communication unit which requests the spoolers based on the information indicating spoolers acquired by the acquisition unit to send a list of print jobs of that user, and receives a list of print jobs as responses from the spoolers to the requests, an operation unit which displays print jobs based on the list of print jobs received from the respective spoolers by the communication unit in a selectable state, and an image forming unit which executes, when a specific print job is selected by the operation unit, image forming processing based on the selected print job.

A network system according to one aspect of the present invention is a system in which a terminal and an image forming apparatus are connected via a network, and a plurality of spoolers which are configured to be accessed by the image forming apparatus are connected on the network, the terminal comprising a user information acquisition unit which acquires user information of a user who issues a save instruction of a print job, a print job save processing unit which saves a print job of the user acquired by the user information acquisition unit in one of the spoolers connected to the network, and a spooler information registration processing unit which registers, in a data table for the user, information associated with the spooler in which the print job is saved, and the image forming apparatus comprising a user authentication unit which authenticates a user, an acquisition unit which acquires information indicating spoolers used by the user whose authentication by the user authentication unit has succeeded from the data table, a communication unit which simultaneously requests the spoolers based on the information indicating spoolers acquired by the acquisition unit to send a list of print jobs of that user, and sequentially receives a list of print jobs as responses from the spoolers to the requests, an operation unit which displays print jobs based on the list of print jobs received from the respective spoolers by the communication unit in a selectable state, and an image forming unit which executes, when a specific print job is selected by the operation unit, image forming processing based on the selected print job.

An image forming method according to one aspect of the present invention comprises authenticating a user, acquiring information indicating spoolers used by the user whose authentication has succeeded, requesting the spoolers based on the acquired information indicating spoolers to send a list of print jobs of that user, receiving a list of print jobs as responses from the spoolers to the requests, displaying print jobs based on the list of print jobs received from the respective spoolers in a selectable state, and executing, when a specific print job is selected, image forming processing based on the selected print job.

An image forming method according to one aspect of the present invention is a method used in a network print system in which a terminal and an image forming apparatus are connected via a network, and a plurality of spoolers which are configured to be accessed by the image forming apparatus are connected on the network, comprising, in the terminal, acquiring user information of a user who issues a save instruction of a print job, saving a print job of the user whose user information is acquired in one of the spoolers connected to the network, and registering, in a data table for the user, information associated with the spooler in which the print job is saved and, in the image forming apparatus, authenticating a user, acquiring information indicating spoolers used by the user whose authentication has succeeded from the data table, simultaneously requesting the spoolers based on the acquired information indicating spoolers to send a list of print jobs of that user, sequentially receiving a list of print jobs as responses from the spoolers to the requests, displaying print jobs based on the list of print jobs received from the respective spoolers in a selectable state, and executing, when a specific print job is selected, image forming processing based on the selected print job.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing the overall arrangement of a network print system;

FIG. 2 is a schematic block diagram showing an example of the arrangement of the image forming apparatus 1;

FIG. 3 is a flowchart for explaining an overview of the flow of a private print mode;

FIG. 4 is a view showing an example of print jobs registered in a given spooler SP;

FIG. 5 is a view showing an example of a spooler table Ca registered in an IC card C as a storage medium;

FIG. 6 is a view showing an example of a list of print jobs which are acquired by the image forming apparatus 1 from respective spoolers on the network and correspond to a given user;

FIG. 7 is a flowchart for explaining the registration processing of a print job in the private print mode;

FIG. 8 is a flowchart for explaining the print processing in the private print mode; and

FIG. 9 shows a display example of a print job selection window displayed on an operation panel 12 in the print processing in the private print mode.

### DETAILED DESCRIPTION OF THE INVENTION

Preferred embodiments according to the present invention will be described hereinafter with reference to the accompanying drawings.

A network print system according to an embodiment of the present invention will be described below.

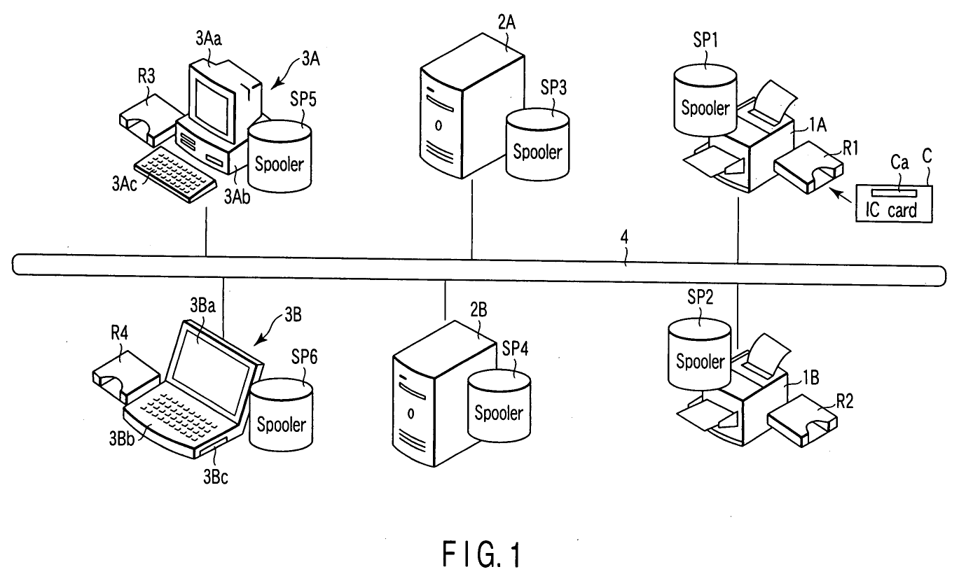

FIG. 1 is a schematic diagram showing the overall arrangement of a network print system.

As shown in FIG. 1, the network print system is formed by connecting image forming apparatuses 1 (1A, 1B), servers 2 (2A, 2B), and terminals 3 (3A, 3B) via a network 4.

Each image forming apparatus 1 is implemented by, e.g., a digital multi-functional peripheral (MFP), network printer, or the like. The image forming apparatus 1 has a function (network print function) of executing print processing in response to a print request from each terminal 3 or the like via the network.

The network print function of the image forming apparatus 1 executes print processing on the basis of a print job spooled by each of spoolers (SP1 to SP6) assured in respective devices connected to the network. In the image forming apparatus 1, a spooler SP (SP1, SP2) that spools a print request from the terminal 3 or the like as a print job is assured.

A reader/writer R (R1, R2) of a storage medium is connected to the image forming apparatus 1. The reader/writer R (R1, R2) has a function of reading information stored in a storage medium, and a function of writing information in the storage medium. The storage medium from/on which data is read/written by the reader/writer R need only be a portable one by the user. For example, an IC card, memory card, portable storage device, a portable terminal, or the like may be applied. Note that this embodiment assumes an IC card C as the storage medium.

The IC card C as the storage medium is possessed by each user. The IC card C stores user information including authentication data of each user. The IC card C stores a spooler table Ca (to be described later). Note that the spooler table Ca may be assured on another device on the network 4. In this case, the IC card C may store information required to access the spooler table Ca of the user of interest.

Each server 2 (2A, 2B) has a function as a spool server that spools a print request to the image forming apparatus 1 (1A, 1B). In the server 2 (2A, 2B), a spooler SP (SP3, SP4) that spools a print request as a print job is assured.

Each terminal 3 (3A, 3B) is a device used by the user. The terminal 3 comprises, e.g., a personal computer (PC) or the like. The terminal 3 (3A, 3B) has a display unit 3a (3Aa, 3Ba), operation unit 3b (3Ab, 3Bb), and processor 3c (3Ac, 3Bc).

The display unit 3a comprises a display device. The operation unit 3b comprises an operation device such as a keyboard, mouse, or the like. The processor 3c has a CPU as a controller, various memories as a storage unit, a display controller for controlling the display unit 3a, an interface for the operation unit 3b, a communication interface for network communications, and the like. The processor 3c has a function of executing various kinds of processing when the CPU or the like executes application programs stored in the storage unit.

A reader/writer R (R3, R4) of the IC card C as the storage medium is connected to the processor 3c of the terminal 3. Each of the reader/writers R3 and R4 has a function of reading information stored in the IC card C as the storage medium, and a function of writing information in the IC card C as the storage medium as in the reader/writers R1 and R2. The processor 3c of the terminal 3 includes a spooler SP (SP5, SP6) that spools a print request as a print job.

This network print system is premised on the presence of a plurality of spoolers. If the network print system has only one spooler, data such as print jobs in the network print system are concentrated on one spooler. Such concentration of data is not preferable in terms of fault tolerance and security. That is, by providing the plurality of spoolers on the network in this network print system, a system which is robust against faults and has security is provided.

Note that the system arrangement shown in FIG. 1 indicates an arrangement when spoolers are respectively assured in a plurality of devices. However, the plurality of spoolers need not be assured in all the devices on the network. The plurality of spoolers used in this network print system can be assured as needed in accordance with the user's environments, system design, or security policy.

An example of the arrangement of the image forming apparatus 1 will be described below.

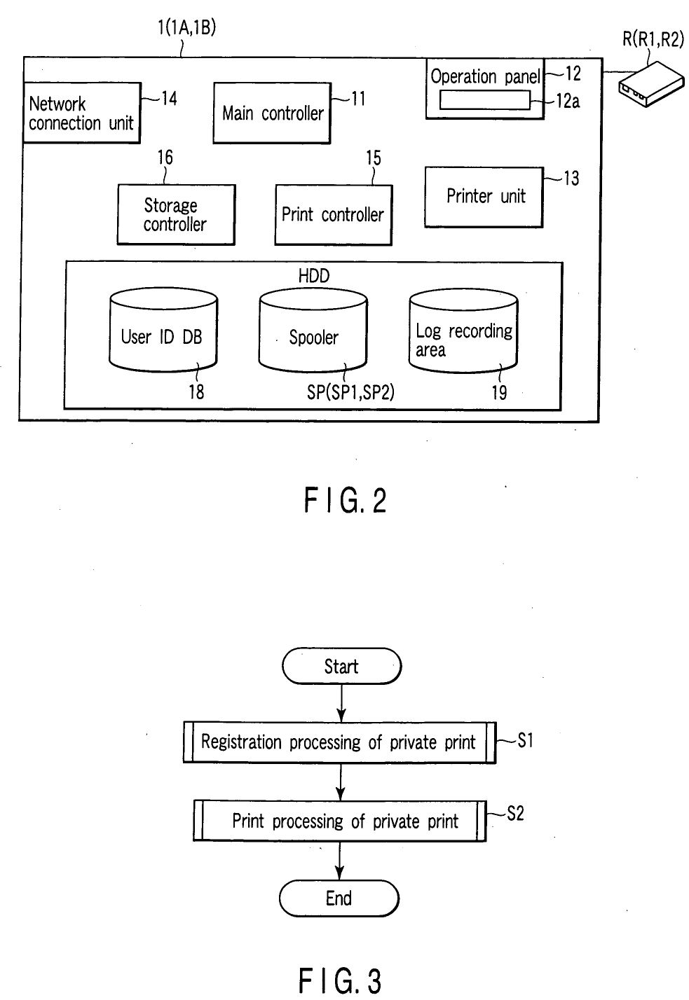

FIG. 2 is a schematic block diagram showing an example of the arrangement of the image forming apparatus 1.

As shown in FIG. 2, this image forming apparatus 1 has a main controller 11, operation panel 12, printer unit 13, network connection unit 14, print controller 15, storage controller 16, hard disk drive (HDD) 17, and the like.

The reader/writer R is connected to the image forming apparatus 1. The reader/writer R has a function of reading information stored in the IC card C as the storage medium presented by the user, and a function of writing information in the IC card C, as described above. For example, the information read from the IC card C as the storage medium by the reader/writer R is supplied to the main controller 11.

The main controller 11 controls the overall image forming apparatus. The main controller 11 has a function of controlling respective units. The main controller 11 has a CPU (Central Processing Unit), RAM (Random Access Memory), ROM (Read Only Memory), nonvolatile memory, image processor, and the like. The main controller 11 implements various kinds of processing or various functions when the CPU executes control programs stored in the ROM, nonvolatile memory, HDD 17, or the like.

The operation panel 12 is a user interface that receives operation instructions from the user. The operation panel 12 has hardware keys such as a numeric keypad or the like, and a display unit 12a comprising a touch-panel built-in display device. The display unit 12a of the operation unit 12 displays operation guidance messages, touch keys, and the like. The operation panel 12 detects an input to a given touch key on a touch panel displayed on the display unit 12a.

The printer unit 13 forms an image on an image forming medium. The printer unit 13 comprises a convey unit (not shown) for conveying the image forming medium, an image forming unit (not shown) for forming a color or monochrome image on the image forming medium conveyed by the convey unit, and the like. The printer unit 13 prints image data on the image forming medium under the control of the print controller 15. The print controller 15 controls print processing using the printer unit 13 in accordance with a request from the main controller 11.

The network connection unit 14 controls data communications via the network 4. The network connection unit 14 comprises a network interface card (NIC) or the like required to connect the network 4. In the example of the arrangement shown in FIG. 1, the network connection unit 14 realizes data communications with the server 2 or terminal (PC) 3 via the network 4.

The storage controller 16 controls input/output data to/from the HDD 17. Data is read out from or written in HDD 17 under the control of the storage controller 16. The HDD 17 is also used as a backup memory of various data, and stores various setting data or management data. The HDD 17 also stores data or the like received via the network 4 as needed.

The HDD 17 is assured with a user information database (DB) 18, spooler SP, log recording area 19, and the like.

The user information database 18 is a database for storing user information. The user information database 18 stores user IDs and authentication data in association with each other for respective users. The user ID is identification information of each user. The authentication data is data required to execute authentication processing of the user specified by the user ID. As the authentication data, a password or the like is used. Note that the authentication data need only be information that can authenticate the user and, for example, biometric information or the like may be used.

Note that the user information database 18 may be assured in another device on the network 4 or in the IC card C. That is, the user information database 18 need only be assured to be acquired upon executing the network print function by the image forming apparatus 1.

The spooler SP spools a print request from each device on the network 4 as a print job. Note that the spooler need only be assured to implement the network print function by the image forming apparatus 1 in the network system, as described above. For example, if a spooler is assured in another device on the network, which can be accessed by the image forming apparatus 1, no spooler SP may be assured in the image forming apparatus 1.

The log recording area 19 is a database for storing the processing result of print processing and the like. For example, the log recording area 19 records information indicating histories of various kinds of processing such as registration of a print job in the spooler of the image forming apparatus, a list request of print jobs to be described later, a download request of a print job from each spooler of another device, and the like. Note that the log recording area 19 may be assured in another device on the network, which can be accessed by the image forming apparatus 1.

The network print function in the network print system with the above arrangement will be described below.

In the network print function in the network print system, the image forming apparatus 1 executes a print job requested from the terminal 3 or the like via the network 4. Furthermore, as a type of network print function, a function called private print (or security print) is available. The private print function is a function of executing the network print function in a state wherein security is guaranteed for the print result (printed sheets).

In the aforementioned network print system, each image forming apparatus 1 is shared by a plurality of users. For this reason, when each image forming apparatus 1 sequentially executes print processing in response to various print requests from respective devices on the network 4 as the normal network print function, paper sheets printed are sequentially exhausted on the image forming apparatus 1 according to such print requests. In other words, in the normal network print function, the image forming apparatus 1 has a state wherein paper sheets as the print results of print requests from an unspecified number of users are exhausted. In such state, an unspecified user can easily secretly look at the print result based on a print request of another person.

Contrary to such normal network print function, the private print function executes print processing while security is guaranteed for a print request from a given user. That is, in the private print function, a print request from a given user is kept spooled in any spooler on the network as a print job. The image forming apparatus 1 downloads the print job from that spooler in response to a print instruction of that user, and executes print processing.

Such private print function means that the print processing requested by the user of interest is executed while that user is near the image forming apparatus 1. Therefore, the private print function can improve the security of the print result since the print job is executed while the user is near the image forming apparatus 1.

An overview of the private print function will be described below.

FIG. 3 is a flowchart for explaining an overview of the flow of the private print function.

As shown in FIG. 3, the private print function is roughly implemented by two types of processing. That is, the private print function is implemented by registration processing (step S1) that registers a print job to be executed as a private print job in a spooler, and print processing (step S2) in which the image forming apparatus executes print processing on the basis of the print job registered by this registration processing.

For example, the user designates private print processing at the terminal 3. Then, the terminal 3 executes registration processing for registering (storing) user information of that user and print data of the private print mode in the spooler SP as a print job.

The user inputs an execution instruction of the private print processing registered using the terminal 3 at the image forming apparatus 1. Then, the image forming apparatus 1 executes print processing that executes print processing (private print) on the basis of the print job as the private print job registered in the spooler SP in accordance with the user's operation.

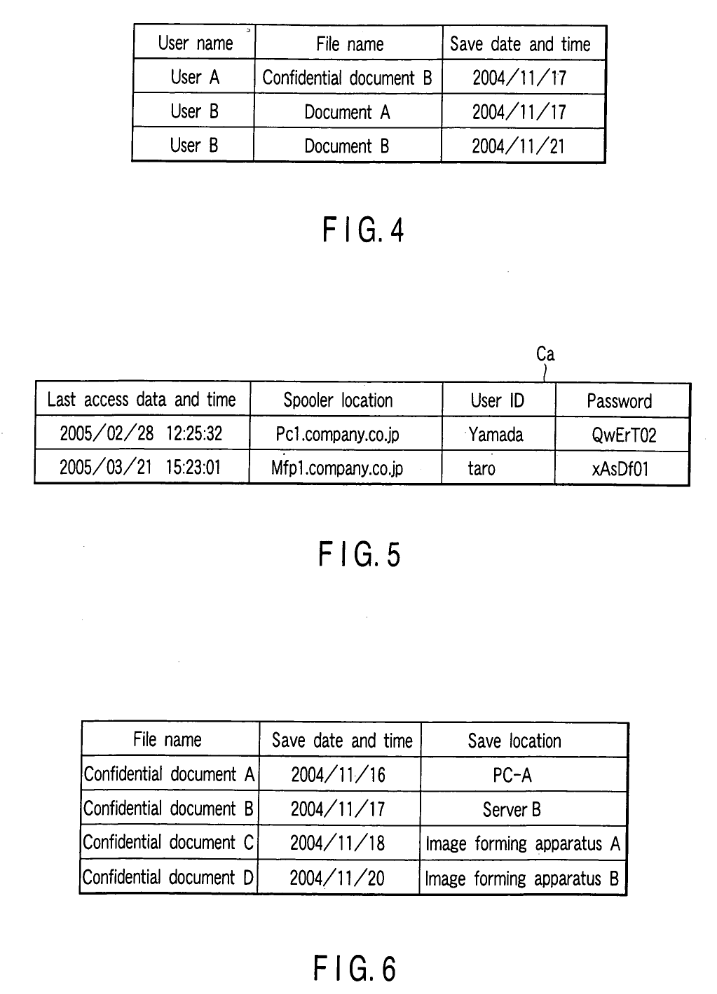

FIG. 4 shows an example of print jobs registered in a given spooler SP.

Each spooler SP registers (saves) print jobs in accordance with private print requests from respective devices on the network 4. The aforementioned print job as the private print job includes user information, print data, and the like.

In the example shown in FIG. 4, the spooler SP saves a user name (user ID), file name, and save date and time as information required to manage each print job. The user name (user ID) is information required to identify a user who requested the aforementioned private print processing. Hence, print jobs for each user are retrieved based on the user name (user ID). The file name is information indicating a file as print data of the print job of interest. The save date and time include information indicating the date and time when the print job of interest is registered in that spooler.

FIG. 5 shows an example of the spooler table Ca registered in the IC card C as a portable storage medium possessed by the user.

In the IC card C as a portable storage medium possessed by the user, information indicating a spooler that registers a print job of private print processing is registered in the spooler table Ca. In the example shown in FIG. 5, the spooler table Ca stores the last access date and time, spooler location, user ID, password, and the like for each spooler.

The last access date and time include information indicating the date and time when the user identified by the user ID accessed last. The spooler location is information indicating the location of the spooler of interest on the network. In other words, the spooler location is access information required to access the spooler of interest in the network system.

The user ID is information required to identify the user. Print jobs registered in the spooler can be retrieved using the user ID. That is, the user ID is information corresponding to the user name (user ID) registered in the spooler. For example, the user ID is information corresponding to the user name in management information of a print job in the spooler shown in FIG. 4.

The password is authentication data required to authenticate if the user of interest is the user specified by the user ID. Therefore, whether or not the user of interest is the user specified by the user ID is authenticated by collating authentication data designated by the user with the password.

Note that the spooler table Ca may be assured on a device on the network 4 so as to be accessed from the terminal 3 or image forming apparatus 1. In this case, the IC card C may store information required to access the spooler table Ca of the user of interest.

FIG. 6 shows an example of a list of print jobs which are acquired by the image forming apparatus 1 from the plurality of spoolers on the network, and correspond to a given user.

The list of print jobs corresponding to the specific user shown in FIG. 6 is generated by the image forming apparatus 1 in print processing to be described later. The image forming apparatus 1 collects information indicating print jobs corresponding to the user, whose authentication has succeeded, from spoolers registered in the spooler table in the IC card C presented by that user. Based on the information indicating print jobs collected from these spoolers, the image forming apparatus 1 generates a list of print jobs.

The list of print jobs indicates the file name, save date and time, save location, and the like as information indicating print jobs collected from the respective spoolers in the example shown in FIG. 6. The file name is information indicating a file as print data. The file name is also used as a print job name indicating a print job. The save date and time include information indicating the date and time when the print job of interest is registered (saved). The save location is information indicating the name (or location on the network) of a spooler (or a device having that spooler) where the print job of interest is registered.

The registration processing in the private print mode will be described in detail below.

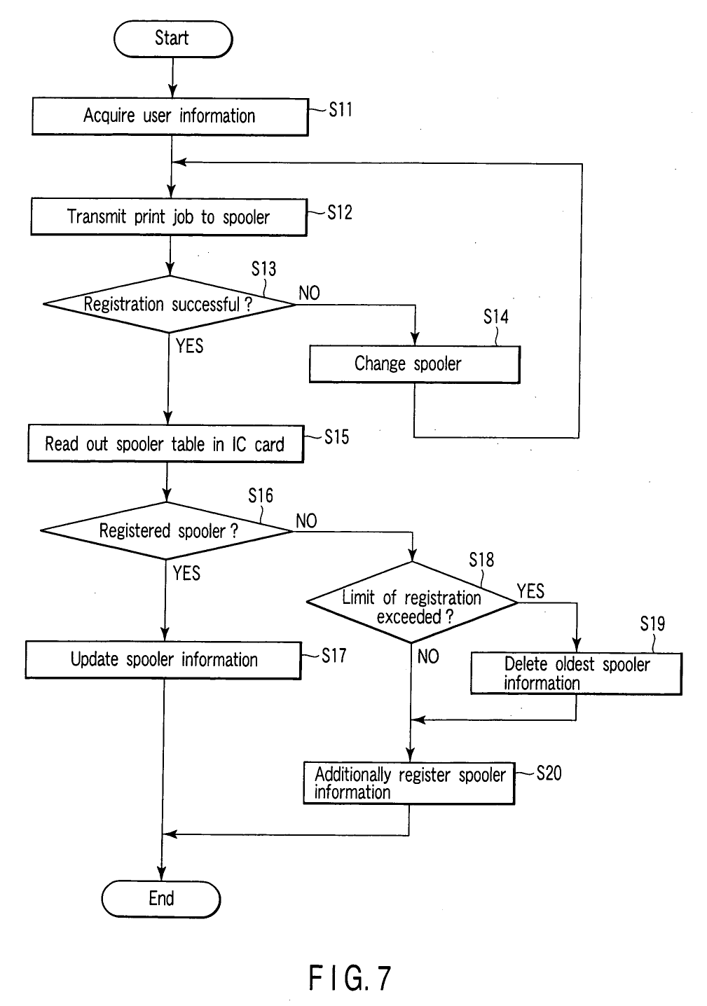

FIG. 7 is a flowchart for explaining the registration processing of a print job in the private print mode.

The following description will be given under the assumption that, for example, the terminal 3A registers a private print job designated by the user in the spooler SP4 of the server 2B in the system arrangement shown in FIG. 1.

The user inserts the IC card C into the reader/writer R3 at the terminal 3A. In this state, the user designates print data using the operation unit 3Ab, and designates the private print mode with reference to the display screen of the display unit 3Aa. Note that the user may insert the IC card C into the reader/writer R3 after he or she designates the private print mode.

For example, when the user wants to execute private print processing of a file opened by an application program at the terminal 3A, he or she launches a printer driver program for executing network print (private print) processing by operating the operation unit 3Ab. After the printer driver program is launched, the user designates the private print mode to have data of that file as print data by operating the operation unit 3b.

After the user designates the private print mode, the processor 3Ac of the terminal 3A acquires user information (user ID or the like) required to specify the user as an executant of the private print mode. (step S11). For example, the user information is acquired from the IC card C set in the reader/writer R3. Alternatively, the user may input the user information by operating the operation unit 3Ab.

After the user information is acquired, the processor 3Ac of the terminal 3A transmits the acquired user information and print data as a private print registration request (save request) to the server 2B having the spooler SP4 which is set in advance (step S12). In this case, assume that the spooler SP4 is set in advance as a spooler used to spool the print job of interest of the private print mode.

Note that when there are a plurality of spoolers in the network print system, as shown in FIG. 1, a spooler used to spool a print job of the private print mode may be designated by the user via the printer driver program.

Upon reception of the private print registration request from the terminal 3A, the server 2B registers the received user information and print data in the spooler SP4 as a print job of the private print mode. In this case, the spooler SP4 saves a file as the print data, and registers management information of that print job shown in FIG. 4. After the print job is registered in the spooler SP4, the server 2B notifies the terminal 3A of completion of registration.

The processor 3Ac of the terminal 3A which transmitted the private print registration request to the server 2B checks in accordance with response status from the server 2B if registration (saving) of the print job of interest in the spooler SP4 has succeeded (step S13).

If no response is received from the server 2B within a predetermined period of time or if a registration failure message is received from the server 2B as a result of this checking step, the processor 3Ac of the terminal 3A determines that registration of the print job in the spooler SP4 has failed (NO in step S13).

More specifically, if a communication with the server 2B cannot be established (if the server 2B cannot be accessed via the network), the terminal 3A cannot obtain any response from the server 2B. Therefore, if no response is received from the server 2B within the predetermined period of time, the processor 3Ac of the terminal 3A determines that registration of the print job in the spooler SP4 has failed. If the capacity of the spooler SP4 reaches a limit or if the spooler SP4 suffers a trouble, the terminal 3A receives a registration failure message from the server 2B. Therefore, if the registration failure message is received from the server 2B, the processor 3Ac of the terminal 3A determines that registration of the print job in the spooler SP4 has failed.

If it is determined that registration of the print job of the private print mode in the spooler SP4 has failed, the processor 3Ac of the terminal 3A changes the spooler used to spool that print job to a spooler other than the spooler SP4 (step S14).

After the spooler used to register the print job is changed, the processor 3Ac of the terminal 3A controls the flow to return to step S12, and sends the registration request of the print job to a device having the changed spooler. In this case, assume that a spooler other than the spooler SP4 is set in advance as the spooler to be changed. Alternatively, the terminal 3A may select an arbitrary spooler other than the spooler SP4.

Upon reception of the registration completion message of the print job from the server 2B, the processor 3Ac of the terminal 3A determines that registration (saving) of the print job in the spooler SP4 has succeeded (YES in step S13).

If it is determined that registration of the print job of the private print mode in the spooler SP4 has succeeded, the processor 3Ac of the terminal 3A reads out the spooler table Ca from the IC card C set in the reader/writer R3 (step S15). The spooler table Ca registers the list of spoolers which were previously used by the user of interest, as shown in FIG. 5.

That is, if registration of the print job of interest in the spooler SP4 has succeeded, the processor 3Ac of the terminal 3A reads out a list of registered spoolers from the spooler table Ca in the IC card C set in the reader/writer R3. After the list of registered spoolers is read out from the spooler table Ca, the processor 3Ac of the terminal 3A checks if the spooler SP4 in which the print job of interest is registered has already been registered in the spooler table Ca (step S16).

If it is determined that the spooler SP4 has already been registered in the spooler table Ca (YES in step S16), the processor 3Ac of the terminal 3A updates the information of the spooler SP4 in the spooler table Ca of the IC card C set in the reader/writer R3 (step S17). For example, in the spooler table Ca shown in FIG. 5, information indicating the last access date and time is updated to the current date and time.

On the other hand, if it is determined that the spooler SP4 has not been registered in the spooler table Ca yet (NO in step S16), the processor 3Ac of the terminal 3A checks if the number of spoolers registered in the spooler table Ca of the IC card C set in the reader/writer R3 is equal to or larger than a predetermined limit value (step S18).

If it is determined in step S18 that the number of spoolers registered in the spooler table Ca is equal to or larger than the limit value (YES in step S18), the processor 3Ac of the terminal 3A deletes information of the oldest spooler (a spooler with the oldest last access date and time in the spooler table Ca shown in FIG. 5) in the spooler table Ca (step S19). After the information of the oldest spooler is deleted, the processor 3Ac of the terminal 3A additionally registers information pertaining to the spooler SP4 in which the print job is registered in the spooler table Ca (step S20).

On the other hand, if it is determined in step S18 that the number of spoolers registered in the spooler table Ca is smaller than the limit value (NO in step S18), the processor 3Ac of the terminal 3A additionally registers information pertaining to the spooler SP4 in which the print job is registered in the spooler table Ca (step S20).

Note that the processes in steps S18 and S19 delete spooler information from the spooler table Ca of the IC card C on the basis of a predetermined condition. In this embodiment, the number of spoolers to be registered in the spooler table Ca is limited, and when the number of spoolers to be registered in the spooler table Ca becomes equal to or larger than the limit value, the oldest spooler is deleted. As the processes in steps S18 and S19, information of a spooler with a smallest frequency of use or a spooler which is a predetermined period of time or more old may be deleted.

The processes in steps S18 and S19 are executed to reduce the capacity of a storage area used as the spooler table Ca to be equal to or smaller than a predetermined size. In general, a storage medium such as the IC card C or the like has a small storage capacity of the memory, and the storage capacity that can be used in various applications is often limited. For this reason, when a spooler that does not meet the predetermined condition is deleted from the spooler table, the storage capacity used as the spooler table Ca can be reduced to a predetermined size or less.

Furthermore, by deleting information of a spooler with a smallest frequency of use or a spooler which is not used for a predetermined period, a spooler to be registered in the spooler table Ca can be efficiently used. In the print processing in the private print mode to be described later, a print job is retrieved from each spooler registered in the spooler table Ca. For this reason, by deleting unnecessary spooler information from the spooler table, efficient processing can be implemented.

The print processing in the private print mode will be described in detail below.

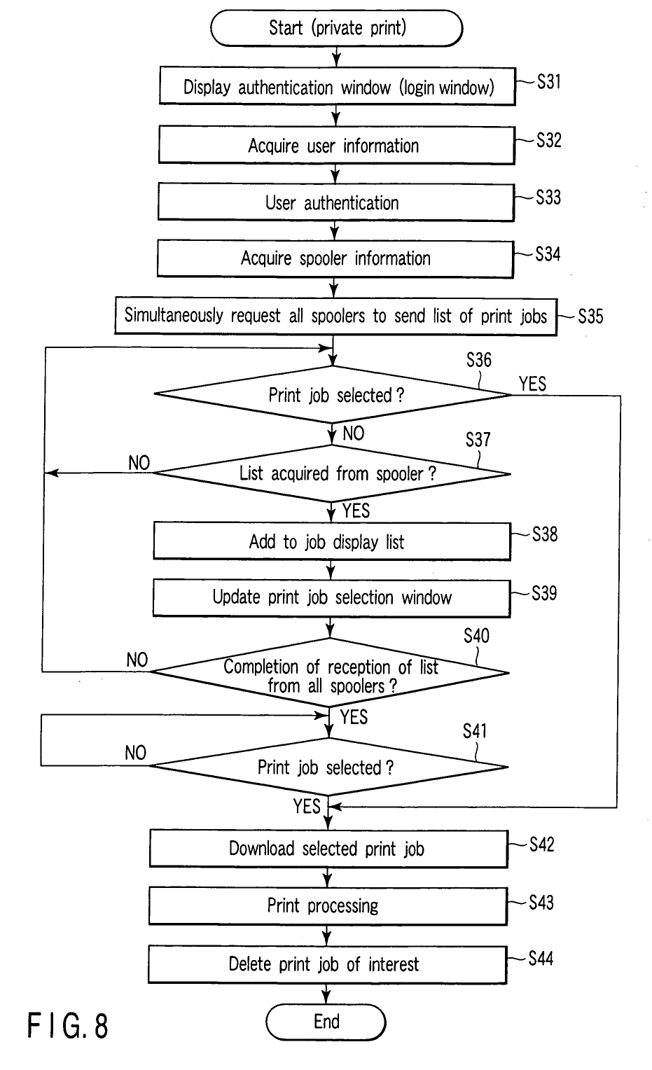

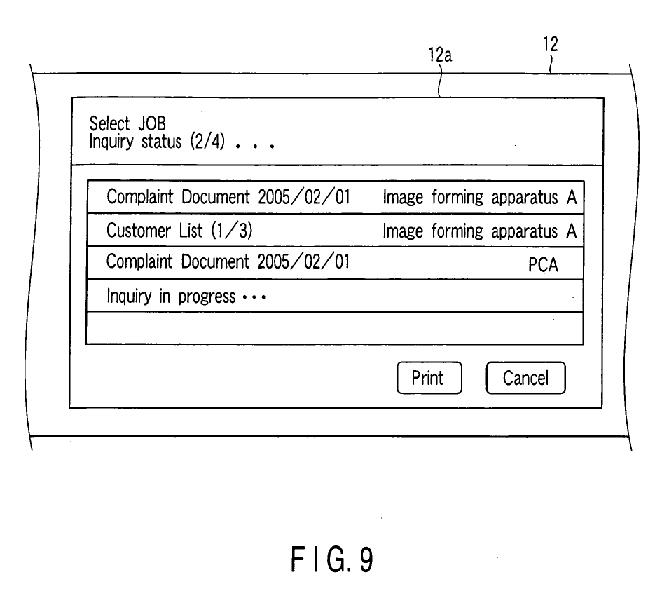

FIG. 8 is a flowchart for explaining the print processing in the private print mode. FIG. 9 shows a display example of a print job selection window displayed on the operation panel 12 in the print processing in the private print mode.

The print job of the private print mode registered in an arbitrary spooler SP on the network 4 by the aforementioned registration processing is executed as the print processing based on the private print function by the image forming apparatus 1.

That is, the user who executed the registration processing of the print job of the private print mode by the aforementioned registration processing selects a private print function from the operation panel 12 of the image forming apparatus 1. Then, the main controller 11 of the image forming apparatus 1 displays a user authentication window (login window) on the operation panel 12 (step S31).

The user authentication window displays an insertion guidance message of the IC card possessed by the user, and an input guidance message of a user ID and password corresponding to that user ID as user authentication data. If one IC card per user (per user ID) is assumed, an input guidance message of only a password may be displayed, or an input guidance message of the user ID and password may be omitted. In this case, the user ID, or the user ID and password may be acquired from the IC card.

However, if it is assumed that one IC card C is used by a plurality of users (or one user uses a plurality of user IDs), the operation panel 12 displays the insertion guidance message of the IC card and the input guidance message of a user ID and password corresponding to that user ID as user authentication data.

While such authentication window is displayed, the user inserts the IC card C into the reader/writer R, and inputs the user ID and password using the operation panel 12. In this way, the main controller 11 acquires user information designated by the user himself or herself (step S32).

After the user information is acquired, the main controller 11 performs user authentication by collating the acquired user information with that registered in the user information database 18 (step S33). When the user information database 18 is assured in an external apparatus, the user authentication processing is done by collating the acquired authentication data with that registered in the user information database 18 assured in the external apparatus.

If the user authentication has succeeded, the main controller 11 reads out all the pieces of spooler information corresponding to the user ID of the user whose authentication has succeeded from the spooler table Ca of the IC card C inserted in the reader/writer R (step S34).

After all the pieces of spooler information which are registered in the spooler table Ca of the IC card C and correspond to the user ID are read out, the main controller 11 executes processing for asynchronously requesting all these spoolers to send a list of print jobs of that user, and prompting the user to select a desired print job from the list of print jobs obtained as responses to these requests (steps S35 to S41).

More specifically, the main controller 11 simultaneously requests devices having spoolers (devices that manage the spoolers) on the basis of all the pieces of spooler information which are registered in the spooler table Ca of the IC card C and correspond to the user ID to send a list of print jobs corresponding to that user ID (step S35).

In response to this request from the image forming apparatus 1, the devices having the spoolers retrieve all print jobs corresponding to the user ID and return the retrieval results to the image forming apparatus 1. The devices which manage the spoolers have different processing performances, operating states, connection conditions to the network, and the like. For this reason, a time from when the image forming apparatus 1 requests the respective devices to send a list until it receives responses from the devices changes depending on the devices.

The main controller 11 of the image forming apparatus 1 which requested the spoolers (devices having the spoolers) to send a list of print jobs displays a print job selection window on the display unit 12a of the operation panel 12, and prompts the user to select a print job (step S36). The main controller 11 generates a list (job display list) indicating print jobs that can be selected by the user in an internal memory or the like (not shown). In a state wherein no responses are received from the respective devices (initial state), there is no print job in the job display list. For this reason, a message indicating that inquiries about print jobs to the spoolers are in progress is displayed on the print job selection window.

Every time the main controller 11 of the image forming apparatus 1 receives a list of print jobs from the spooler (YES in step S37), it adds the list of print jobs to the job display list (step S38). After the print jobs are added to the job display list, the main controller 11 displays (updates) the print job selection window that displays all the print jobs included in the current job display list as well as those added to the job display list in a selectable state on the display unit 12a of the operation panel 12 (step S39).

After the print job selection window is updated, the main controller 11 checks if reception of the list of print jobs is complete by seeing if responses are received from all the spoolers (step S40). If it is determined that reception of the list of print job is not complete (NO in step S40), the main controller 11 controls the flow to return to step S36, and waits for selection of a print job by the user or a response from the next spooler.

In this state, if the user selects a specific print job and inputs a print start instruction (YES in step S36), the main controller 11 controls the flow to jump to step S42. On the other hand, if a response from the next spooler is detected (YES in step S37) while the user does not select any print job (NO in step S36), the main controller 11 repetitively executes the processes in steps S38 to S40.

If it is determined that reception of the list of print jobs is complete (NO in step S40), the main controller 11 displays the selection window which displays all print jobs acquired from all the spoolers in a selectable state on the display unit 12a of the operation panel 12, and waits for selection of a print job by the user in that state. In this state, if the user selects a specific print job and inputs a print start instruction (YES in step S41), the main controller 11 controls the flow to jump to step S42.

On the other hand, if reception of responses from all the devices is not complete yet, the list of print jobs which are selectable at the present time is displayed in a selectable state, and a guidance message indicating that there are devices whose inquiries are in progress is displayed on the print job selection window.

FIG. 9 shows a display example of the print job selection window to be displayed when reception of responses from all the devices is not complete yet. The display example shown in FIG. 9 displays the print job selection window to be displayed when responses are received from two out of four spoolers. The selection window shown in FIG. 9 displays a guidance message that prompts the user to select a print job, and a guidance message indicating that two out of four inquiries to spoolers are completed (2/4).

Also, the selection window shown in FIG. 9 displays three print jobs collected from two spoolers (image forming apparatus A and PCA) in a selectable state together with a print key and cancel key. Note that the print key is a key used to issue a print start instruction of the selected print job. The cancel key is a key used to issue a cancel instruction of processing.

Furthermore, the selection window shown in FIG. 9 displays “inquiry in progress . . . ” in a display column of a selection item so as to clarify the presence of a spooler whose inquiry is in progress.

For example, when a desired print job corresponds to one of the three print jobs displayed on the selection window shown in FIG. 9, the user selects the desired print job and touches the print key. With this operation, the main controller 11 controls the flow to advance to step S42, and starts print processing of the print job of user's choice.

On the other hand, when a desired print job does not correspond to any of the three print jobs displayed on the selection window shown in FIG. 9, the user waits until print jobs of the two spoolers whose inquiries are in progress are displayed. In this case, every time the main controller 11 acquires a list of print jobs from each of the two remaining spoolers, it displays the acquired list of print jobs on the print job selection window.

In this embodiment, the display processing of the print job selection window and the processing for acquiring the list of print jobs from each spooler are parallelly executed. In this way, an inquiry about print jobs can be efficiently made to each spooler, and the time required until the user acquires a desired print job can be shortened. At the time when print jobs are acquired from each spooler, the user can select a print job. For this reason, user's operability can be improved.

Even when print jobs acquired from some spoolers are displayed on the print job selection window, no print job desired by the user may be displayed. For this reason, when there are spoolers whose inquiries are in progress, the print job selection window displays the presence of the spoolers whose inquiries are in progress in a way easy to understand. In this manner, even when no desired print job is displayed on the print job selection window, a user-friendly operation window can be provided without confusing the user.

If the user selects a specific print job on the print selection window and inputs a print start instruction (YES in step S36 or YES in step S41), the main controller 11 executes processing for downloading the print job of user's choice from that spooler (step S42). In this download processing, a download request of the print job is sent to the spooler (device having the spooler) which saves the print job of user's choice, and print data of the print job is downloaded from the spooler.

After the print job is downloaded, the main controller 11 executes print processing based on the downloaded print job (step S43). Upon completion of this print processing, the main controller 11 executes processing for deleting that print job from the spooler from which the print job was downloaded (step S44). In this deletion processing, a deletion request of the print job is issued to the spooler (device having the spooler) which saves the downloaded print job, and the processing is completed upon reception of the deletion completion message of the print job from the spooler. Note that a message indicating completion of the downloaded print job may be sent to the spooler (device having the spooler), and the spooler that receives the message may delete the print job.

As described above, in this embodiment, the IC card possessed by the user registers information of a spooler which saves a print job of the private print mode. Upon executing the private print processing, the image forming apparatus acquires a list of spooler from the IC card, and simultaneously requests spoolers in the acquired list to send a list of print jobs corresponding to the user. The image forming apparatus presents print jobs to the user in the order they are acquired from the spoolers in response to the requests. When the user selects a desired print job from the presented print jobs, the image forming apparatus downloads the selected print job, and executes its print processing.

In this manner, even when the system includes a plurality of spoolers, processing for acquiring a print job of a specific user from the plurality of spoolers can be efficiently executed in the private print mode.

The image forming apparatus limits spoolers which save print jobs that the user can select by the list of spoolers acquired from the IC card, and requests these limited spoolers to send a list of print jobs of that user. That is, the image forming apparatus can simultaneously request the spoolers acquired from the IC card to send a list of print jobs that the user can select. As a result, the image forming apparatus can efficiently acquire print jobs of that user from respective spoolers.

Print jobs that the user can select are sequentially presented to the user when a list of print jobs is acquired from each spooler. In this way, the user can quickly designate a desired print job.

Furthermore, even when no print job desired by the user is not immediately presented, the image forming apparatus informs the user of the presence of spoolers whose inquiries are in progress. In this manner, the user can make operations without any confusion.

When the user presents the IC card and designates the private print mode, the terminal saves a print job of the private print mode designated by the user in one of spoolers in the system. The terminal registers information of the spooler that saves the print job in the IC card presented by the user. In this manner, every time the user designates the private print mode, information of the spooler that saves the print job of the private print mode can be registered in the IC card. As a result, the processing for registering the spooler information in the IC card can be efficiently executed.

When the information of the spooler that saves the print job is registered in the IC card, if the number of spoolers which have already been registered in the IC card is equal to or larger than a predetermined limit value, the terminal deletes the oldest spooler information, and then registers the information of the spooler that saves the print job. In this fashion, the size of spooler information to be saved in the IC card can be held to a predetermined size or less.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a user authentication unit which authenticates a user;
an acquisition unit which acquires information indicating spoolers used by the user whose authentication by the user authentication unit has succeeded;
a communication unit which requests the spoolers based on the information indicating spoolers acquired by the acquisition unit to send a list of print jobs of that user, and receives a list of print jobs as responses from the spoolers to the requests;
an operation unit which displays print jobs based on the list of print jobs received from the respective spoolers by the communication unit in a selectable state; and
an image forming unit which executes, when a specific print job is selected by the operation unit, image forming processing based on the selected print job.

2. An image forming apparatus according to claim 1, wherein the acquisition unit acquires the information indicating spoolers used by the user whose authentication by the user authentication unit has succeeded, by reading the information from a data table for the user.

3. An image forming apparatus according to claim 1, wherein the acquisition unit acquires, from a portable storage medium possessed by the user, the information indicating spoolers used by the user whose authentication by the user authentication unit has succeeded by reading the information.

4. An image forming apparatus according to claim 1, wherein the communication unit simultaneously requests the spoolers based on the information indicating the spoolers acquired by the acquisition unit to send a list of print jobs of the user.

5. An image forming apparatus according to claim 1, wherein the operation unit displays print jobs based on the received list of print jobs in a selectable state every time the communication unit receives a list of print jobs from each spooler.

6. An image forming apparatus according to claim 5, wherein the operation unit displays print jobs based on the received list of print jobs in a selectable state every time the communication unit receives a list of print jobs from each spooler, and displays the presence/absence of a spooler in a waiting state of a response to the request of the list of print jobs.

7. A network print system in which a terminal and an image forming apparatus are connected via a network, and a plurality of spoolers which are configured to be accessed by the image forming apparatus are connected on the network,
the terminal comprising:
a user information acquisition unit which acquires user information of a user who issues a save instruction of a print job;
a print job save processing unit which saves a print job of the user acquired by the user information acquisition unit in one of the spoolers connected to the network; and
a spooler information registration processing unit which registers, in a data table for the user, information associated with the spooler in which the print job is saved, and
the image forming apparatus comprising:
a user authentication unit which authenticates a user;
an acquisition unit which acquires information indicating spoolers used by the user whose authentication by the user authentication unit has succeeded from the data table;
a communication unit which simultaneously requests the spoolers based on the information indicating spoolers acquired by the acquisition unit to send a list of print jobs of that user, and sequentially receives a list of print jobs as responses from the spoolers to the requests;
an operation unit which displays print jobs based on the list of print jobs received from the respective spoolers by the communication unit in a selectable state; and
an image forming unit which executes, when a specific print job is selected by the operation unit, image forming processing based on the selected print job.

8. A network print system according to claim 7, wherein the spooler information registration processing unit of the terminal registers, in a portable storage medium possessed by the user, the information associated with the spooler in which the print job is saved.

9. A network print system according to claim 7, wherein when the information associated with the spooler in which the print job is saved has already been registered in the data table, the spooler information registration processing unit of the terminal updates the information associated with the spooler in which the print job is saved, and when the information associated with the spooler in which the print job is saved is not registered in the data table, the spooler information registration processing unit additionally registers the information associated with the spooler in which the print job is saved.

10. A network print system according to claim 7, wherein when the number of pieces of spooler information which have already been registered in the data table is not less than a predetermined limit, the spooler information registration processing unit of the terminal deletes at least one piece of information associated with the spooler based on a predetermined deletion condition, and then registers, in the data table, the information associated with the spooler in which the print job is saved.

11. An image forming method comprising:
authenticating a user;
acquiring information indicating spoolers used by the user whose authentication has succeeded;
requesting the spoolers based on the acquired information indicating spoolers to send a list of print jobs of that user;
receiving a list of print jobs as responses from the spoolers to the requests;
displaying print jobs based on the list of print jobs received from the respective spoolers in a selectable state; and
executing, when a specific print job is selected, image forming processing based on the selected print job.

12. An image forming method according to claim 11, wherein the information indicating spoolers used by the user whose authentication has succeeded is acquired by reading the information from a data table for the user.

13. An image forming method according to claim 11, wherein the information indicating spoolers used by the user whose authentication has succeeded is acquired by reading the information from a portable storage medium possessed by the user.

14. An image forming method according to claim 11, wherein the spoolers based on the acquired information indicating the spoolers are simultaneously requested to send a list of print jobs of the user.

15. An image forming method according to claim 11, wherein displaying the print jobs in the selectable state includes displaying print jobs based on the received list of print jobs in a selectable state every time a list of print jobs is received from each spooler.

16. An image forming method according to claim 15, wherein displaying the print jobs in the selectable state includes displaying print jobs based on the received list of print jobs in a selectable state every time a list of print jobs is received from each spooler, and displaying the presence/absence of a spooler in a waiting state of a response to the request of the list of print jobs.

17. An image forming method used in a network print system in which a terminal and an image forming apparatus are connected via a network, and a plurality of spoolers which are configured to be accessed by the image forming apparatus are connected on the network, comprising:
in the terminal,
acquiring user information of a user who issues a save instruction of a print job;
saving a print job of the user whose user information is acquired in one of the spoolers connected to the network; and
registering, in a data table for the user, information associated with the spooler in which the print job is saved, and
in the image forming apparatus,
authenticating a user;
acquiring information indicating spoolers used by the user whose authentication has succeeded from the data table;
simultaneously requesting the spoolers based on the acquired information indicating spoolers to send a list of print jobs of that user;
sequentially receiving a list of print jobs as responses from the spoolers to the requests;
displaying print jobs based on the list of print jobs received from the respective spoolers in a selectable state; and
executing, when a specific print job is selected, image forming processing based on the selected print job.

18. An image forming method according to claim 17, wherein registering the information associated with the spooler includes registering the information in a portable storage medium possessed by the user.

19. An image forming method according to claim 17, wherein registering the information associated with the spooler includes updating, when the information associated with the spooler in which the print job is saved has already been registered in the data table, the information associated with the spooler in which the print job is saved, and additionally registering, when the information associated with the spooler in which the print job is saved is not registered in the data table, the information associated with the spooler in which the print job is saved.

20. An image forming method according to claim 17, wherein registering the information associated with the spooler includes deleting, when the number of pieces of spooler information which have already been registered in the data table is not less than a predetermined limit, at least one piece of information associated with the spooler based on a predetermined deletion condition, and then registering, in the data table, the information associated with the spooler in which the print job is saved.
